(19) United States
(12) Patent Application Publication
(10) Pub. No.: US 2006/0093724 A1
(43) Pub. Date: May 4, 2006

(54) Frozen food

(75) Inventors: Qing Qi, Lisle, IL (US); Gijsbert Kuil, Vlaardingen (NL); Jill Nicole Pavlovich, Elk Grove Village, IL (US)

Correspondence Address: UNILEVER INTELLECTUAL PROPERTY GROUP, 700 SYLVAN AVENUE,, BLDG C2 SOUTH, ENGLEWOOD CLIFFS, NJ, 07632-3100, US

(73) Assignee: Conopco, Inc., a corporation of New York d/b/a Unilever Foodsolutions

(21) Appl. No.: 10/980,495

(22) Filed: Nov. 3, 2004

(51) Int. Cl. A23L 1/40

(52) U.S. Cl. 426/589

(57) ABSTRACT

Phospholipo-proteins which have been enzyme modified may be used as an emulsifier to improve the emulsion stability of frozen products, e.g., during the freeze thaw and vacuum cool processes. Especially preferred is use of the enzyme phospholipase A to modify egg yolk and to use the modified egg yolk as an emulsifier in frozen products. Creation of a more stable emulsion can be expected to improve the overall appearance of the final product both in the frozen state and after the product has been reheated. Although egg yolk is preferred, examples of other phospholipo-protein containing substances include casein, skim milk, buttermilk, whey, cream, soybean, yeast, whole egg, blood serum and wheat proteins.

### BACKGROUND OF THE INVENTION

During the last decade, food service began to enjoy greater significance within the food industry. In the midst of increasingly complex lives, and with the amount of time available for preparation and consumption of meals steadily decreasing, consumers found the convenience and speed of eating in restaurants or of bringing home ready-to-consume foods difficult to resist.

Proprietors of restaurants and other establishments which serve foods have other concerns in addition to providing an expeditious dining experience. The food industry and the public receive periodic reminders of how important it is that foods which are served in restaurants and elsewhere are appropriately preserved. Refrigeration at freezing, or sometimes higher, temperatures is one common method of preserving foods.

Manufacture of frozen foods for use in restaurants and other establishments presents some challenges, however. For instance, the appearance and organoleptic impact of the food should resemble that of the fresh food counterpart, notwithstanding the freezing, thawing and heating to which the frozen food may be subjected. This means that where the food is in the form of an emulsion it is important that the emulsion be stable notwithstanding the temperature stresses to which it is subjected.

Various emulsifiers have been used in different types of foods.

van Dam, U.S. Pat. No. 4,034,124 is directed to emulsions comprising an oil phase, an aqueous phase and a phospholipo-protein which has been subjected to a treatment with phospholipase A as emulsion stabilizer. The emulsions are said to have an increased stability, especially heat stability, compared with other emulsions. Examples of emulsions discussed by van Dam include margarines, soups or sauces, natural or artificial fruit juices, mayonnaise, dressings, spreads and non-edible products such as toilet preparations. Examples of phospholipo-protein containing substances include egg yolk, which is preferred. Storage of the emulsions including modified egg yolk for several weeks at a temperature between 20° and 5° C. followed by storage at 37° C. was said not to show oil exudation. Table 5 is said to show that samples prepared with modified whole egg were stable under usual temperature conditions in a refrigerator.

van Dam, U.S. Pat. No. 4,119,564 is directed to oil-in-water emulsions with an increased viscosity produced by incorporating an effective amount of phospholipase A treated phospholipo-protein. The invention is particularly related to dressings and mayonnaise.

Schenk, U.S. Pat. No. 5,028,447 is directed to oil and water emulsions which contain a phospholipo-protein material which has been modified by phospholipase A, and at least one native starch-based thickening agent. No after gelling or water separation is detected upon storage for 15° C. for twelve (12) months.

Lecithin, mono/diglycerides, dairy proteins and polysorbate are known emulsifiers for use in frozen products.

### SUMMARY OF THE INVENTION

The invention is directed to the discovery that phospholipo-proteins which have been enzyme modified may be used as an emulsifier to improve the emulsion stability of frozen products, e.g., during the freeze thaw and cooling and freezing processes. Especially preferred is use of the enzyme phospholipase A to modify egg yolk and use of the modified egg yolk as an emulsifier in the frozen products. Creation of a more stable emulsion can be expected to improve the overall appearance of the final product both in the frozen state and after the product has been reheated.

Although egg yolk is preferred, examples of other phospholipo-protein containing substances include casein, skim milk, buttermilk, whey, cream, soybean, yeast, whole egg, blood serum and wheat proteins. Egg yolk and/or other sources of phopholipo-protein can be subjected to the action of phospholipase A or other enzyme, and then the modified product incorporated into the products of the invention. Alternatively, it is possible to isolate the phospholipo protein from its source and subject the isolated protein to the action of phospholipase A, after which the modified phopholipo-protein is incorporated into the frozen food products of the invention. In addition, it is expected that the phospholipoprotein could be enzyme-modified in its source and then isolated from the source.

Examples of emulsion-containing frozen foods which can be expected to benefit from the present invention include frozen sauces, frozen pastas, frozen pasta-containing dishes, Frozen Soups, and Frozen Cream. Examples of suitable frozen sauces include Hollandaise sauce, Alfredo Sauce, creamy Alfredo Sauce, other cream and butter sauces and soups. The emulsions according to the invention can be either oil or water continuous or bi-continuous.

In accordance with a preferred application of the invention, the soups and sauces containing emulsions are exposed to heat process temperatures between 80 and 90° C., then cooled to 10° C. and stored for up to one year (12 months) in the frozen state at temperatures between −10 and 0° C. The frozen product is then heated to approximately 80° C. and held for up to 4 hours at temperatures between 60-80° C.

For a more complete understanding of the above and other features and advantages of the invention, reference should be made to the following detailed description of preferred embodiments.

### DETAILED DESCRIPTION OF THE INVENTION

The frozen products according to the invention are made in a similar fashion to prior frozen products except that modified phospholipoproteins are used as the emulsifier.

The expression “modified” applied to phospholipo-protein as used herein denotes any degree of conversion brought about by the action of phospholipase A. Phospholipase A is an enzyme which effects cleavage of the bond binding a fatty acid radical to the glycerol part of the phospholipid molecule, thereby replacing this fatty acid radical by an OH-group, which is called conversion. Phospholipase A is also active when the phospholipid is complexed with protein (and then called phospholipo-protein in this specification).

Phospholipases other than phospholipase A are not preferred. A suitable source of phospholipase A is pancreatin which is preferably heat-treated, preferably under acidic conditions. The enzyme composition thus obtained is substantially free from enzymatic activity other than that resulting from phospholipase A, which is remarkably stable under the conditions of the above treatment. Another suitable source of phospholipase A is phospholipase A 10,000 from Nordmark Werke Hamburg, which does not contain amylases, has a lipase activity of 0.8×10⁻⁴ IU/mg and a proteolytic activity equivalent to 2.3% pure trypsine.

Phospholipids form a class of chemical compounds comprising as the main elements phosphatidylcholine and phosphatidylethanolamine and further some sphingonyelin, phosphatidylserine and phosphatidylinositol. All these compounds can form protein complexes.

The degree of conversion of modified phospholipo-protein is in this specification expressed as the percentage of converted phosphatidylcholine plus phosphatidylethanolamine based on the total amount of phosphatidylcholine plus phosphatidylethanolamine present before conversion. An easy method to obtain the figures required to compute this percentage is quantitative thin-layer chromatography.

The degree of conversion is determined, inter alia, by the temperature and pH at which, and the period of time during, which incubation of the phospholipo-protein with phospholipase A takes place as well as by the concentration of the enzyme and the presence of activating agents such as Ca²⁺ ions or deactivating agents such as Zn²⁺, Cd²⁺, Pb²⁺, EDTA, during this incubation.

It has been found that even a very low degree of conversion contributes to the emulsifying capacity of the modified phospholipo-protein as well as to the heat stability of the emulsion containing it. It has however also been found that the presence of unmodified phospholipo-protein is detrimental to the beneficial effects of the modified composition, without, however, totally off-setting these. Thus one would normally expect that replacing in an emulsion the entire modified phospholipo-protein content having a degree of conversion of say 40% by an equivalent amount of equal parts of unmodified phospholipo-protein and modified phospholipo-protein having a degree of conversion of 80%, would make no difference in the properties of the emulsion. It has been found, however, that the latter emulsion is appreciably less heat-stable than the former, although the latter emulsion is also appreciably better in this respect than an emulsion stabilized by an equivalent amount of unmodified phospholipo-protein.

It has been found that the degree of conversion should preferably be 10%. Particularly preferred emulsions according to the invention are emulsions in which the degree of conversion of the modified phospholipo-proteins contained therein is between 40% and 86%, especially between 50% and 60%. On the one hand a degree of conversion of 40% is easily attainable and on the other hand it ensures a very satisfactory emulsifying capacity and heat stability of the emulsion. Degrees of conversion higher than 60%, although well suitable, are somewhat less easy to obtain.

The modification can be carried out under different conditions (temperature, incubation time, concentration of the enzyme etc.), which can easily be determined by the man skilled in the art. A proportion varying from 0.002 mg-0.2 mg phospholipase A per gram phospholipo-protein is suitable. This range holds for a phospholipase A composition having a specific activity of about 70 U/mg protein. IU means that 1 micro equivalent fatty acid is released per minute.

Modification with these phospholipases A leaves the phospholipo-protein complex intact. Careful isolation by centrifugation of lipo-protein fractions from modified and from unmodified egg yolk showed that the phospholipid part of modified egg yolk consisted of lyso-compounds, in other words the modification takes place in situ without splitting of the protein-lipid bond.

The quantity of modified phospholipo-protein which should be present in the emulsion can vary within very wide limits. This quantity is inter alia dependent on the composition of the emulsion, the presence of other emulsifying agents, the degree of conversion of the modified phospholipo-protein and the properties which are desired in the stabilized emulsion. The actual quantity to be used can easily be determined by those skilled in the art of stabilizing emulsions.

Proportions considerably lower than, sometimes 1/15 of those normally applied when using unmodified material, can be applied with comparable emulsifying efficiency when modified phospholipo-protein is used. In the latter case the emulsions obtained are often heat-stable to a large degree. Moreover, in accordance with the present invention, the emulsions can be used in frozen foods as well. One of the special advantages of the emulsions according to the invention is that these emulsions have an improved stability for frozen foods.

As a general guideline according to the invention emulsions are preferred which contain between 0.05 and 5%, preferably between 0.5 and 4%, by weight of modified phospholipo-protein based on the oil (or fat-containing oil) content of the emulsion.

Enzyme Modified Egg Yolk is available from, for example, Michael Foods Inc. of Minneapolis, Minn.

If desired, the emulsions according to the invention may include at least one starch-based thickening agent as described in Schenk U.S. Pat. No. 5,028,447, the disclosure of which is hereby incorporated by reference.

### EXAMPLE 1

A creamy Alfredo sauce with the following formula is prepared:

| Description | Proportion |
|---|---|
| Water | 0.25 |
| Dry ingredient mixture | 0.02 |
| Butter | 0.13 |
| Enzyme Modified Egg Yolk | 0.02 |
| Cream | 0.42 |
| Nonfat dry milk | 0.02 |
| Cheese Flavor | 0.01 |
| Disodium Phosphate | 0.00 |
| Natural cheese | 0.13 |
| Butter Flavor | 0.00 |
| Creamy Alfredo | 1.00 |

The process is as follows:
Butter is completely melted in a steam jacket kettle by heating to 145° F., and then transferred to a mix tank when called for.
Dry ingredient mix is mixed in a, mix tank until a homogenous mixture (slurry) (free of bumps) is achieved, and is transferred to the kettle when needed.
Formula amount of water is added to the mix tank, along with the enzyme modified egg yolk which is then mixed for 3 minutes. The melted fat is then added, as is an antifoam process aid, and mixed for another 3 min. The thus-prepared emulsion is then transferred to the cooking kettle and chased through the line with formula amount of chase water.
Cream is added to a mix tank and heated to 140° F. Non-fat dry milk, and cheese flavors are then added to the mix tank. The mixture is transferred to the cooking kettle.
The slurry, emulsion, dairy blend and disodium phosphate are added to the cooking kettle then heated to 190° F. and held for 10 minutes. Before adding, disodium phosphate is dissolved in hot water. It is then heated to 190° F. and held for 10 minutes.
Natural cheeses are then added to the cooking kettle, heated to 175° F. and held for 10 min.
Butter flavor is added and held for 1 min.
The sauce is cooled (from about 170° F.) to 50° F.
The product is then packed and frozen.

What is claimed is:

1. A frozen food product comprising an emulsion, and phospholipoprotein which has been enyzmatically modified.

2. The frozen food product according to claim 1 wherein the modified phospholipoprotein is in the form of one or more of: enzyme modified egg yolk, casein, skim milk, buttermilk, whey, cream, soybean, yeast, whole egg, blood serum or wheat proteins.

3. The frozen food product according to claim 1 wherein the product is selected from the group of frozen sauces, frozen soups, frozen pastas and frozen pasta-containing dishes.

4. The frozen food product according to claim 3 wherein the frozen sauces are selected from the group of hollandaise sauce, Alfredo sauce, and other cream, and butter sauces.

5. A method of making a frozen food product comprising adding enzyme modified phosopholipoprotein to further food ingredients and freezing the ingredients to a temperature between −10 and 0° C.

6. The method according to claim 4 wherein the food ingredients are mixed together prior to freezing.
